(19) United States
(12) Patent Application Publication
(10) Pub. No.: US 2007/0226382 A1
(43) Pub. Date: Sep. 27, 2007

(54) Method for improving direct memory access performance

(76) Inventors: Johnny Chiu, Taipei (TW); Herbert Wang, Taipei (TW); Hueilin Chou, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,843

(22) Filed: Jan. 17, 2007

(30) Foreign Application Priority Data
Mar. 7, 2006 (TW) 095107577

(51) Int. Cl. G06F 13/28

(52) U.S. Cl. 710/22

(57) ABSTRACT

A method for direct memory access (DMA) data transfer is adapted for a computer system having a microprocessor, a chipset, a memory with a physical region description (PRD) table and a DMA engine. In the method, a first group of PRD entries including at least two PRD entries of the PRD table by the DMA engine is fetched during a single PRD entry fetching cycle. Accordingly, a first group of blocks of data of the memory corresponding to the first group of PRD entries is accessed in sequence

### FIELD OF THE INVENTION

The present invention relates to data communication in a computer system and, more particularly, to a direct memory access (DMA) transfer method.

### BACKGROUND OF THE INVENTION

For current data transfer technique applied to a microcomputer system with a microprocessor, a chipset and a main memory, data is transferred between the microcomputer system and peripheral devices in two ways. One is that the data transference is controlled by the microprocessor, such as Central Processing Unit (CPU), and the other is that the data communication is processed by a specific component, such as a direct memory access (DMA) engine or controller.

Particularly, by way of DMA transfer, the DMA engine may control data communication without significant intervention of the microprocessor. For example, the peripheral device is able to read or write a block of data into a buffer of the peripheral device via the DMA engine but not the microprocessor. Therefore, the microprocessor is freed to perform other tasks, so that the processing speed of the microcomputer system is improved.

Referring to FIG. 1, which illustrates a conventional computer system allowing DMA data transfer. The computer system in FIG. 1 comprises a microprocessor 10, a chipset 20, a memory 30 and a peripheral device 40 with a DMA engine 45. The peripheral device 40 connects to the chipset 20, and the chipset 20 connects with the microprocessor 10 and the memory 30.

When the computer system is going to transfer a block of data to the peripheral device 40, the only thing the microprocessor 10 has to do is to store the block of data into the memory 30 via chipset 20, and then it may perform other task. Meanwhile, the DMA engine 45 in the peripheral device 40 receives a specific address of the block of data from the chipset 20, accesses the block of data in the memory 30 through the chipset 20 according to the specific address, and stores the block of data into a buffer 451 of the DMA engine 45.

In general, under the DMA transfer mechanism, the blocks of data are stored in memory spaces and are identified with respective physical region description (PRD) entries. A PRD entry is used for describing information of a block of data, such as memory address, data status, length, and PRD entry of the next block of data. The memory spaces usually are scattered to various locations. Nevertheless, the scattered memory spaces can be gathered via corresponding PRD entries.

The DMA engine 45 generally fetches a PRD entry of a desired block of data from the memory 30, and then accesses the block of data stored in specific memory space according to a memory address described in the PRD entry, and stores the block of data into the buffer 451 finally. The peripheral device 40 issues a response signal to the PRD entry to rewrite the data status described by the PRD entry. After that, the DMA engine 45 accesses the next block of data according to the PRD entry described in the current PRD entry. Similarly, the peripheral device 40 may also issue a response signal to rewrite the data status of the next block of data.

Referring to FIG. 2, which is a flow chart of conventional DMA data transfer method. The method starts at step 51, where the DMA engine 45 fetches a 1st PRD entry from the memory 30. At step 52, the DMA engine 45 accesses a 1st block of data according to the memory address presented in the 1st PRD entry, stores the 1st block of data into the buffer 451, and then transfers the 1st block of data to a predetermined target address. After the 1st block of data transfer has completed, the method goes to step 53, where the DMA engine 45 fetches a 2nd PRD entry from the memory 30. At step 54, the DMA engine 45 accesses 2nd block of data according to memory address presented in the 2nd PRD entry, stores the 2nd block of data into the buffer 451, and then transfers the 2nd block of data to the predetermined target address. Assuming that the memory 30 stores N PRD entries therein, obviously, the DMA engine 45 cannot be freed until the Nth block of data transfer completes.

Noted that the memory 30 has to issue a memory cycle to fetch a separate PRD entry. That means the DMA engine 45 fetches one PRD entry every time, and will not fetch next PRD entry until the block of data corresponding to current PRD entry transfer has completed. Therefore, such a DMA data transfer manner lengthens the latency of the memory cycle, which is harmful to the computer system performance.

### SUMMARY OF THE INVENTION

In view of the foregoing, methods for direct memory access (DMA) data transfer are provided.

The method for direct memory access (DMA) data transfer is adapted for a computer system having a microprocessor, a chipset, a memory with a physical region description (PRD) table and a DMA engine. The method includes steps of: fetching a first group of PRD entries including at least two PRD entries of the PRD table by the DMA engine during a single PRD entry fetching cycle; and accessing a first group of blocks of data of the memory corresponding to the first group of PRD entries in sequence.

Another method for direct memory access (DMA) data transfer includes steps of: configuring a physical region description (PRD) table comprising a plurality of PRD entries and a plurality of blocks of data corresponding to the PRD entries of the PRD table in the memory, each PRD entry describing a memory address of a corresponding block of data and a PRD entry address of another PRD entry; fetching at least two adjoining PRD entries at one time by the DMA engine for accessing corresponding blocks of data according to memory addresses presented in the fetched PRD entries; and repeating the fetching step until the plurality of blocks of data are completely transferred.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a computer system allowing DMA data transfer;

FIG. 2 is a step diagram of a conventional DMA data transfer;

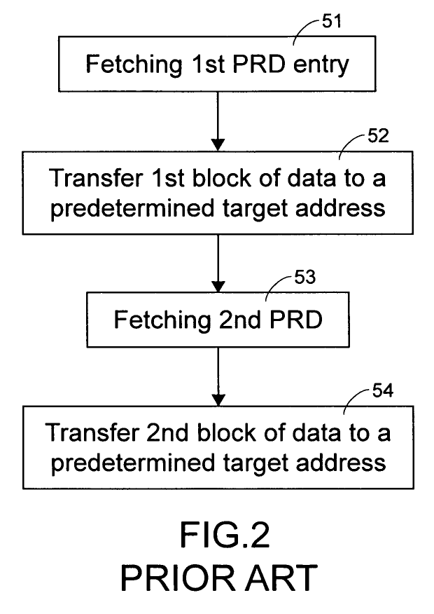

FIG. 3 is another computer system allowing DMA data transfer;

FIG. 4 illustrates PRD tables and blocks of data in accordance with preferred embodiment of the present invention; and

FIG. 5 is a step diagram of a DMA data transfer in accordance with preferred embodiment of the present invention.

### DETAILED DESCRIPTION OF THE INVENTION

Reference will now be made in detail to the preferred embodiments of the invention, a method for direct memory access (DMA) data transfer, examples of which is illustrated with reference of drawings.

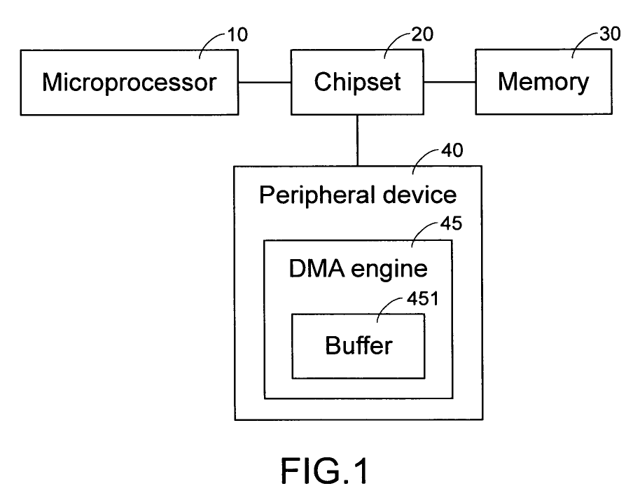

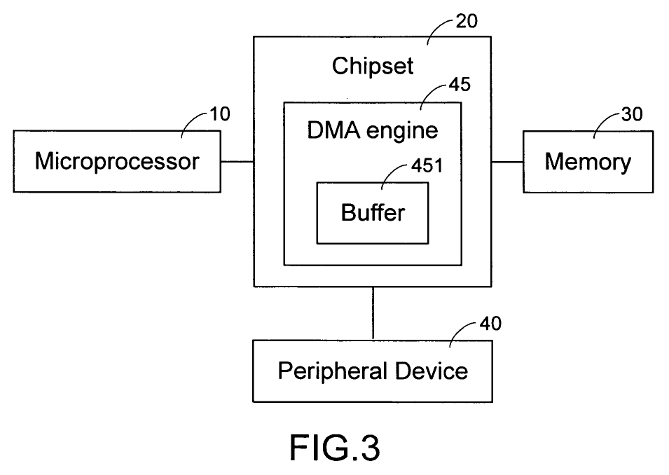

The method for DMA data transfer in accordance with the present invention is adapted to be used in all kinds of computer systems which allow DMA data transfer. As shown in FIG. 1 and FIG. 3, such computer system typically comprises a microprocessor 10, a chipset 20, a memory 30 and a DMA engine or controller 45. The DMA engine 45 could be disposed in a peripheral device 40 (FIG. 1), or in the chipset 20 (FIG. 3). The chipset 20 could be a north bridge, a south bridge or combined north bridge and south bridge. The peripheral device 40 can be an IDE hard disk, PATA hard disk, SATA hard disk, network card, or other electronic device supporting DMA engine or controller.

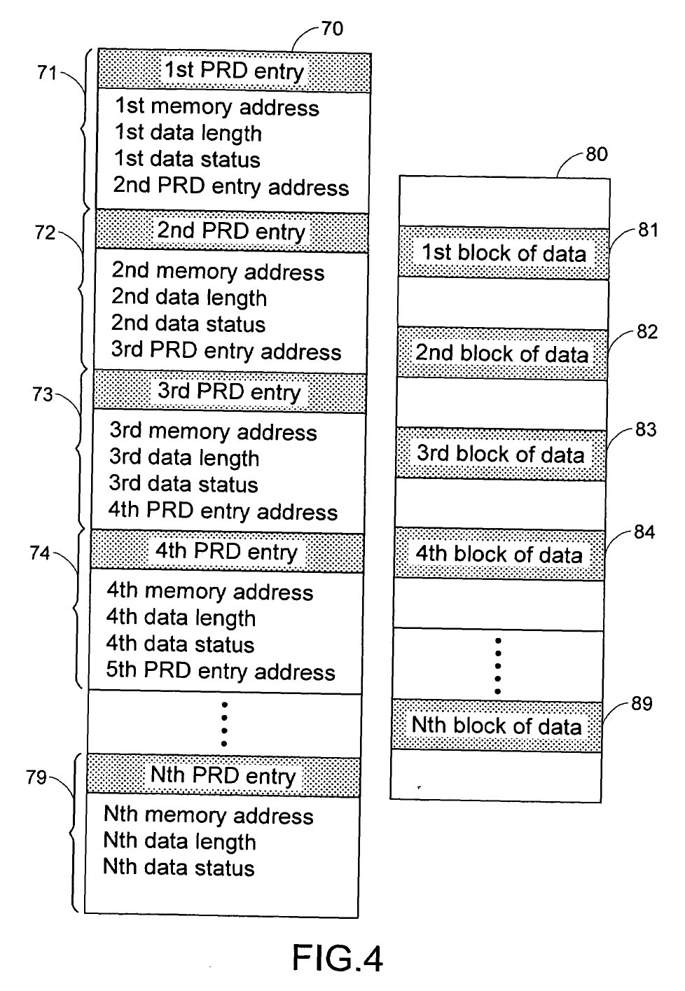

Referring to FIG. 4, which illustrates blocks of data stored in the memory 30. As shown in FIG. 4, the blocks of data are stored in memory spaces 81-89 of storing area 80 and are identified by physical region description (PRD) entries 71-79 in a PRD table 70, respectively. Each of the PRD entries 71-79 is used for describing information of a block of data, such as memory address, data status, length, and PRD entry address of the next PRD entry. The memory spaces 81-89 usually are scattered to various locations, however, the scattered memory spaces 81-89 are gathered via the corresponding PRD entries 71-79.

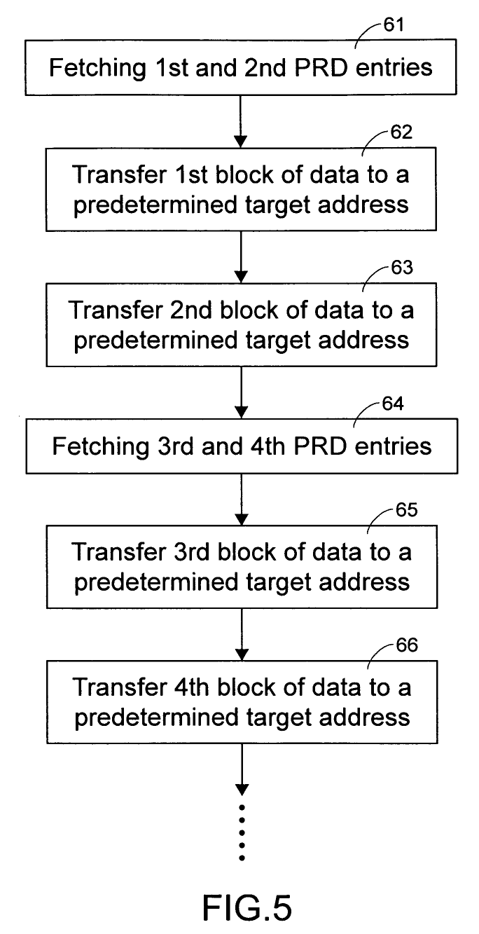

Please refer to FIG. 4 again in conjunction with FIG. 5, which is a flow chart of a method for DMA data transfer in a preferred embodiment of the present invention.

At step 61, the DMA engine 45 accesses to the memory 30 through the chipset 20 and fetches a bunch of PRD entries stored in the PRD table 70 at one time. Assuming that one bunch of PRD entries comprises at least two separate PRD entries, the DMA engine 45 will fetch a 1st PRD entry 71, and then prefetch a 2nd PRD entry 72 according to 2nd PRD entry address presented in the 1st PRD entry 71.

At step 62, the DMA engine 45 accesses a 1st block of data 81 together with a 2nd block of data 82 according to memory addresses respectively presented in the 1st PRD entry 71 and 2nd PRD entry 72, stores the 1st block of data 81 and the 2nd block of data 82 into a buffer 451 of the DMA engine 45, and then transfers the 1st block of data 71 to a predetermined target address. The buffer 451 could be a (First-In First-Out) FIFO.

After the 1st block of data 71 transfer has completed, the method goes to step 63, where the DMA engine 45 transfers the 2nd block of data 72 to another predetermined target address.

After the 2nd block of data 72 transfer has completed, the method goes to step 64, where the DMA engine 45 accesses to the memory 30 again through the chipset 20 and fetches a 3rd PRD entry 73 and a 4th PRD entry 74 according to the 4th PRD entry address presented in the 3rd PRD entry 73.

At step 65, the DMA engine 45 accesses a 3rd block of data 83 together with a 4th block of data 84 according to memory addresses respectively presented in the 3rd PRD entry 73 and 4th PRD entry 74, stores the 3rd block of data 83 and the 4th block of data 84 in the buffer 451 of the DMA engine 45, and then transfers the 3rd block of data 83 to the predetermined target address.

At step 66, as the 4th block of data 84 has been stored in the buffer 451 in step 65, the DMA engine 45 subsequently transfers the 4th block of data 84 to another predetermined target address after the completion of data transfer of the 3rd block of data 83. The computer system will repeat steps 64-66 until all blocks of data 85-89 corresponding to the PRD entries 75-79 are completely transferred.

It can be seen that the DMA engine 45, using the DMA data transfer method of the preferred embodiment, fetches a bunch of PRD entries at one time, i.e. bunch PRD entry prefetching, and then transfers blocks of data to predetermined target addresses according to the sequence of the accessed bunch of PRD entries. Compared with conventional DMA data transfer method, since the memory addresses for the PRD entries are continuous, the DMA engine 45 adopting the present method may fetch a bunch of PRD entries in every memory cycle, so as to save memory cycle latency for fetching next PRD entry between data transfer cycles. Therefore, the performance of whole computer system is improved.

The present method is adapted for the peripheral devices allowing DMA data transfer, such as IDE hard disk, PATA hard disk, SATA hard disk, network card, or other electronic device supporting DMA engine or controller.

The present method also is adapted for the computer system, which disposes the DMA engine in the chipset, and the chipset can be a north bridge, a south bridge or combined north bridge and south bridge. Moreover, the buffer in the DMA engine can be implemented with a FIFO (first-in-first-out buffer).

In summary, the present method relating to DMA data transfer decreases times of PRD entry fetching by way of bunch PRD entry prefetching, i.e. fetching more than one PRD entry during a single PRD entry fetching cycle, so that memory cycle latency for fetching next PRD entry between data transfer cycles can be saved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for direct memory access (DMA) data transfer in a computer system, the system having a microprocessor, a chipset, a memory with a physical region description (PRD) table, and a DMA engine, the method comprising steps of:
fetching a first group of PRD entries including at least two PRD entries of the PRD table by the DMA engine during a single PRD entry fetching cycle; and
accessing a first group of blocks of data of the memory corresponding to the first group of PRD entries in sequence.

2. The method of claim 1, wherein each PRD entry describes memory address, data status, data length of current block of data and PRD entry address of an adjoining PRD entry.

3. The method of claim 2, wherein the PRD entries in the same group are adjoining PRD entries.

4. The method of claim 2, wherein the DMA engine comprises a buffer.

5. The method of claim 4, further comprising steps of:
storing the first group of blocks of data described by the first group of PRD entries into the buffer of the DMA engine in sequence; and
transferring the first group of blocks of data from the buffer to respective predetermined target addresses according to the sequence of the first group of PRD entries.

6. The method of claim 4, wherein the buffer is implemented with a FIFO (first-in-first-out buffer).

7. The method of claim 1 further comprising steps of:
fetching a second group of PRD entries including at least two adjoining PRD entries of the PRD table;
accessing a second group of blocks of data corresponding to the second group of PRD entries in sequence; and
repeating the PRD-entry fetching and data-block accessing steps until a predetermined number of blocks of data are transferred.

8. The method of claim 1, wherein the DMA engine is disposed in a peripheral device connected to the chipset.

9. The method of claim 8, wherein the peripheral device is selected from an IDE hard disk, PATA hard disk, SATA hard disk, network card, and other electronic device supporting the DMA engine.

10. The method of claim 1, wherein the DMA engine is disposed in the chipset.

11. The method of claim 1, wherein the chipset is selected from a north bridge, a south bridge, and combined north bridge and south bridge.

12. A method for direct memory access (DMA) data transfer in a computer system, the system having a DMA engine and a memory, and the method comprising steps of:
configuring a physical region description (PRD) table comprising a plurality of PRD entries and a plurality of blocks of data corresponding to the PRD entries of the PRD table in the memory, each PRD entry describing a memory address of a corresponding block of data and a PRD entry address of another PRD entry;
fetching at least two adjoining PRD entries at one time by the DMA engine for accessing corresponding blocks of data according to memory addresses presented in the fetched PRD entries; and
repeating the fetching step until the plurality of blocks of data are completely transferred.

13. The method of claim 12, further comprising: storing the accessed blocks of data into a buffer of the DMA engine in sequence.

14. The method of claim 13, wherein the buffer is implemented with a FIFO (first-in-first-out buffer).

15. The method of claim 12, wherein the DMA engine accesses the PRD table in the memory through a chipset.

16. The method of claim 12, wherein each PRD entry further describes data status and data length of the corresponding block of data.
